(19) United States
(12) Patent Application Publication
(10) Pub. No.: US 2006/0202371 A1
(43) Pub. Date: Sep. 14, 2006

(54) Method and plant for the continuous production of sheets of foamed material

(75) Inventors: Hubert Ehbing, Odenthal (DE); Ingo Kellerhof, Neunkirchen-Seelscheid (DE); Rainer Rauhaus, Solingen (DE); Carsten Mohlenkamp, Koeln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/367,175

(22) Filed: Mar. 3, 2006

(30) Foreign Application Priority Data
Mar. 10, 2005 (DE) 102005010999.3

(51) Int. Cl. B29C 44/60; B29C 44/20

(52) U.S. Cl. 264/40.1; 264/45.8; 425/4 C; 425/145

(57) ABSTRACT

The invention relates to a plant and to a method for producing sheets of foamed material in a continuous foam process in which the actual foaming-up profile of the foamed material is detected parallel to the conveying direction of the conveyor belt, a correcting variable for the foam process as a function of a deviation of the actual foaming-up profile from the set or reference foaming-up profile is determined and the process parameter(s) is/are adjusted to make the actual foaming-up profile correspond to the reference foaming profile.

### BACKGROUND OF THE INVENTION

The invention relates to a method and to a plant for producing sheets of foamed material in a continuous foam process, in particular for producing sheets of polyurethane foam.

For the production of flexible slabstock foamed material, various computer- controlled methods for predicting foam properties and for quality assurance in the course of the production of polyurethane foam have become known from, for example, “Software to Manage a Continuous Production of Flexible Polyurethane Foams by Slabstock Technology”, Journal of Cellular Plastics, Volume 33, Mar. 1997, page 102, and “Mathematical Property Prediction Models for Flexible Polyurethane Foams”, Adv. Urethane Sci. Techn. 14 (1998), pages 1 to 44.

For the manufacture of compact polyurethane structural elements by the RIM method, so-called expert systems have been developed for the purpose of optimizing productivity and quality. In “Experten mit System, Prozesssteuerung des PUR-RRIM-Verfahrens zur Herstellung von KarosserieauBenteilen”, Kunststoffe, 88th annual set, 10/98, and in “PUR-Teile kostengiinstig fertigen, Stand der Polyurethan-RRIM-Technologie”, Kunststoffe, 91st annual set, 4/2001, such expert systems for analyzing process parameters in the course of RIM processing are disclosed. These expert systems assist in process monitoring, quality assurance and preventive maintenance.

For the continuous production of foam sheets that are provided with outer layers, DE 28 19 709 B1 describes a method in which the thickness of the foam is detected by ultrasound at right angles to the conveying direction. The manufacturing plant is then controlled via the speed of the conveyor belt and/or via the amount of foam applied. The control algorithm that is described in the method serves reduces loss of quality, reduces operational interruptions, and reduces labor costs.

In DE 102 37 005 A1, a method for monitoring a continuous slabstock-foam process in which the foaming profile in the form of local foam heights is detected continuously along the conveying device is described. Laser distance sensors are preferably employed for this purpose. A correcting variable for controlling the slabstock foam process is ascertained as a finction of possible deviations between the actual foam heights and predetermined set foam heights.

The production of metallic composite elements by continuous or discontinuous methods is known. Devices for continuous production are described in, for example, DE 1 609 668 A, DE 1 247 612 A or DE 92 16 306 U1.

Furthermore, various types of plant for the continuous or discontinuous production of sheets of polyurethane rigid foam and composite sheets of polyurethane rigid foam are known. For example, sheets of polyurethane rigid foam are produced using twin-belt conveying plants. Plants of such a type are commercially available from, for example, Hennecke GmbH, Birlinghovemer Straβ3e 30, 53754 Sankt Augustin, Germany, under the product name CONTIMAT®.

In order to produce a high-quality and reproducible product in the course of the continuous manufacture of sheets of polyurethane foam, an operating state that is as steady as possible should be sought. This state is attained if the entire foaming- up profile possesses a desired shape and remains static, within certain limits, in relation to the environment or, to be more precise, the molding press. To this end, the progress of the reaction of the polyurethane system, the amount of foam applied, the speed of the belt, and the temperature control of the entire plant and of the raw-material components should be harmonized with one another.

DE 196 16 643 C1 describes a method for producing a sheet of foamed material in which the separation of the foaming-up flank from a fixed point is measured upstream of the inlet of the press. The actual value of this separation is compared with a set value, which is dependent on the foamed material, and the working speed of the plant is controlled in accordance with the difference between the actual value and the set value. The formulation and, consequently, the kinetics of the polyurethane system, the applied quantity of the reaction mixture, and also the temperature of the plant are not taken into account.

With adjusted formulation, with known values for height and width of the sheet of foamed material, and with fixed output rate, theoretically the speed of the plant should be capable of being chosen in such a way that the foam just fills the space between the outer layers in the molding-chamber press and no compression of the foam occurs. In practice, this adjustment is not possible and is definitely not desired. The space between the outer layers has to be fully filled with foam. To this end, a certain compaction of the reaction mixture is necessary, without the mixture being deflected excessively in a direction contrary to the direction of travel of the belt. This deflection is called overlapping. Slight overlapping is desirable in some cases, depending on the product, since in this way a slightly undulating surface of the foaming reaction mixture is smoothed, and no bubbles or air pockets are formed below the upper outer layer. Excessive overlapping results in greater friction between the foam and the upper outer layer or the upper wall of the press. The foam cells are stretched in the direction of travel of the belt, and the compressive and tensile strengths in the thickness direction of the sheets are thereby impaired. Furthermore, vertical cracks in the foam sheet may also be formed by this means. On the other hand, the overlapping of the foam—especially in the region of the upper outer layer—leads to reoriented, flat cells. As a rule, this results in lower thermal conductivity values and may be desired for certain applications.

As a result of the exothermic nature of the polyurethane-forming reaction, the temperature-controlled molding-chamber press of the production plant is heated up additionally during the production run. Since this has an effect on the speed of reaction and consequently on the foaming-up profile and the degree of overlapping, controlling countermeasures have to be taken during operation. This can only be done by harmonization of formulation, production speed, quantity applied, the process temperatures and the geometry of the sheet of foamed material to be produced.

The foam expansion profile and, in particular, the overlapping have to be adjusted for the specific product being produced. In order to obtain a constant quality of the sheet of foamed material, care has to be taken to ensure that the foam expansion profile and consequently the overlapping remain the same over the entire production process and from charge to charge. An exact positioning of the profile is, within certain limits, unimportant.

“Foam expansion profile” is understood to be the entire foam expansion contour which forms from the beginning of the expansion until the foam touches the upper outer layer and which can be viewed by an observer watching the expanding foam parallel to the conveying direction of the conveyor belt.

### SUMMARY OF THE INVENTION

The invention provides improved monitoring and improved control of the production of sheets of foamed material in a continuous foam process by detecting the foaming profile parallel to the conveying direction of the conveyor belt and, in particular, the overlapping in the plant. The actual foaming profile and the actual overlapping are compared with a formulation-specific set profile (also referred to as “reference profile). From a possible deviation of the actual profile from the set profile, a correcting variable for the readjustment of the process is ascertained. In contrast to DE 196 16 643 C1, control is not undertaken via the detection of the exact separation from a fixed point but via the detection of the relative values resulting from the actual profile and the set profile.

A particular advantage of the invention is that a qualitative and quantitative monitoring of the foaming operation can be undertaken at an early point in the production cycle. Furthermore, parameters of the plant and/or the composition of the foam-forming material can be adjusted during ongoing production of the foamed material, in order to achieve a product quality that is as constant as possible. As a result, fluctuations in the properties of the product—such as, for example, the compressive strength—are reduced by reason of variable foam expansion behavior or changing overlapping.

Another advantage of the invention is that, by virtue of the detection of the foam expansion profile and of the overlapping already with the start of production, the time for start up of the plant is reduced. In this way, the waste during start up of the production plant can be reduced.

### BRIEF DESCRIPTION OF THE DRAWINGS

FIG. 1 is a schematic representation of a preferred embodiment of the invention in which a process for the continuous production of sheets of foamed material is conducted using a twin-belt conveying plant.

FIG. 2 illustrates a foam expansion profile with little overlapping..

FIG. 3 illustrates a foam expansion profile with strong overlapping.

FIG. 4 illustrates a foaming-up profile with no overlapping.

### DETAILED DESCRIPTION OF THE PREFERRED EMBODIMENTS

In accordance with the present invention, a device for detecting the foam expansion profile or the overlapping is installed upstream of the inlet of the press and parallel to the conveying direction of the conveyor belt. Such detection device preferably includes several laser distance sensors which are arranged on top of one another and/or offset in a manner such that the sensors are capable of measurement of the actual profile of the foam. Alternatively, or additionally, ultrasonic sensors, photoelectric sensors, CCD cameras or other sensors that permit a gauging of the foam profile may also be employed.

In another preferred embodiment, a laser scanner which detects the foam expansion profile two-dimensionally at right angles to the conveying direction is employed. To this end, a laser line is preferably projected onto the foam, and the profile height is determined by triangulation. By using several scanners or by swivelling the laser line at right angles to the conveying direction, the contour of the foam can be mapped over the entire cross-section of the sheet.

In one preferred embodiment of the invention, production of the foamed material is undertaken in a twin-belt conveying plant, for example in a plant of the type which is commercially available under the name CONTIMAT® from Hennecke. Such plants ordinarily have a conveying device on which the expanding foamed material is moved in a conveying direction. As a rule, in such plants, working proceeds with flexible and/or rigid outer layers. The outer layers are guided in the molding-chamber press by conveyor belts.

In another preferred embodiment of the invention, a point-by-point scanning of the foaming profile is undertaken, a fitted curve is constructed by means of the measured actual profile values of the foam, and this fitted curve is compared with a set curve. For example, the difference between the gradients of the curves or the difference of the integrals of the curves in the expansion region is used as a basis for the determination of a correcting variable.

According to another preferred embodiment of the invention, the conveying speed of the expanding foam serves as correcting variable. If, for example, the foaming profile in the form of an integral value differs from the predetermined set profile in such a way that an excessive overlapping arises, the conveying speed is increased until such time as the actual profile coincides sufficiently with the set profile.

According to another preferred embodiment of the invention, the quantity of material supplied to the slabstock-foam process per unit time serves as a correcting variable. If, for example, the foaming profile in the form of an integral value differs from the predetermined set profile in such a way that an excessive overlapping arises, the quantity of material supplied per unit time is diminished until such time as the actual profile and the set profile coincide sufficiently.

According to another preferred embodiment of the invention, the chemical composition of the material supplied to the slabstock-foam process serves as correcting variable. If, for example, the actual profile and the set profile differ from one another too greatly, the chemical composition is changed until such time as the actual profile coincides sufficiently with the set profile. In particular, the quantity of catalyst and/or the quantity of an added physical blowing agent (e.g. pentane) and/or the quantity of water—as a chemically acting blowing agent—can be varied.

According to another preferred embodiment of the invention, the temperature of the reaction components serves as a correcting variable. If, for example, the actual profile and the set profile differ from one another too greatly, the temperature of the reaction components is varied until such time as the actual profile and the set profile coincide again.

According to another preferred embodiment of the invention, the temperatures of the outer layers or of the molding-chamber press serve as a correcting variable. If, for example, the actual profile and the set profile differ from one another too greatly, the temperatures of the outer layers or of the molding-chamber press are changed until such time as the actual profile coincides sufficiently with the set profile.

According to another preferred embodiment of the invention, several different correcting variables are determined on the basis of a deviation of the actual profile from the set profile of the foam, such as, for example, a change in the conveying speed, a change in the temperature of the molding-chamber press or of the outer layers, a change in the quantity of material supplied per unit time, and/or a change in the chemical composition of the supplied material.

According to another preferred embodiment of the invention, at least one product property of the resulting sheet of foamed material is predicted on the basis of the actual profile of the foam. For example, the tensile strength and/or the compressive strength of the foam sheet can be predicted. A rigorous regression model can be used for this prediction. Alternatively, or in addition, a neural network or a hybrid neural network can be used for the prediction. The formulation of the reaction mixture, the conveying speed, the temperature of the molding-chamber press and of the outer layers and the quantity of material supplied per unit time serve as further input variables for the prediction.

According to another preferred embodiment of the invention, the predicted product properties are used to classify the quality of the sheets of foamed material that have been produced. For example, the predicted qualities are saved in a database.

According to another preferred embodiment of the invention, regions of lower quality foamed material produced are identified on the basis of the prediction of at least one product property. Such regions are cut out of the sheet of foamed material. In comparison with the state of the art, this has the advantage that less waste material is produced.

For the most part, sheets of predetermined length (for example, 6 m) are cut out of the foam sheet in a continuous foam-sheet manufacturing process, and the individual sheets are then subjected to a quality check retrospectively. On the other hand, the method according to the invention permits foam sheets for which a lower quality has been predicted to be classified in differing quality grades and to be sorted appropriately.

Preferred embodiments of the invention will be elucidated in more detail in the following with reference to the drawings.

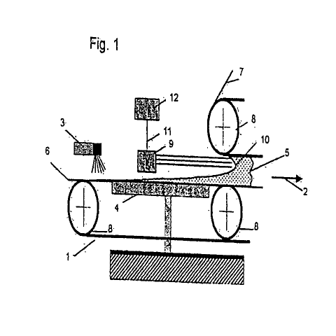

FIG. 1 shows a preferred embodiment of the invention. A twin-belt conveying plant for the continuous production of foam sheets, in particular from poly- urethane foam, is represented. The plant has a conveyor belt I which is moved in the conveying direction 2. At the start of the conveyor belt 1 a mixing head 3 is located above the conveyor belt 1. The mixing head 3 is used to apply a reactive chemical system onto the application plate 4 of the conveyor belt 1. The reactive chemical system is a foaming mixture, for example for the purpose of producing polyurethane foam.

The reactive chemical mixture expands on the conveyor belt 1, so that an expansion region with expanding foam 5 arises. The foam is applied onto a lower outer layer 6. An outer layer 7 is also applied onto the upper side. The outer layers 6 and 7 may be flexible and/or rigid materials. Examples of materials useful as outer layers for insulating boards include: kraft paper, tar paper, bitumen board, crepe paper, PE-coated glass mats and aluminum foils. Structural elements with outer layers that are rigid on both sides are provided with lacquered or coated steel sheet, stainless-steel sheet, wooden sheet, aluminum sheet, or with GRP outer layers. Combination sheets (composites) are obtained if rigid boards (e.g. chipboards, gypsum plasterboards, fiber-reinforced cement boards, glass-fiber boards, rock-wool boards or pearlite boards) are employed as the lower outer layer and if a rollable outer layer is employed as the upper outer layer. The outer layers are supplied via rollers 8. The foaming-up mixture reaches the upper outer layer 7 in the belt channel. By virtue of the defined separation of the upper belt from the lower belt, this region of the plant acts as a press and guarantees an exact sheet thickness.

A measuring device 9 is installed immediately downstream of the mixing head. The measuring device 9 gauges the foaming profile 10 in the expansion region of the foam. The measuring device 9 is connected to a bus system 11. The bus system 11 is connected to a regulator 12. Via the bus system 11, the regulator 12 receives the measurement signals of the measuring device 9. On the basis of these measurement signals, the regulator 12 ascertains a correcting variable for the purpose of readjusting the foam process. For example, the speed of the conveyor belt 1 and/or the quantity of the reactive chemical system supplied per unit time via the mixing head 3 and/or the chemical composition of the system and/or the temperature of the application plate 4 and/or the temperatures of the raw-material components and/or the temperature of the outer layers 6 and 7 serve(s) as the correcting variable.

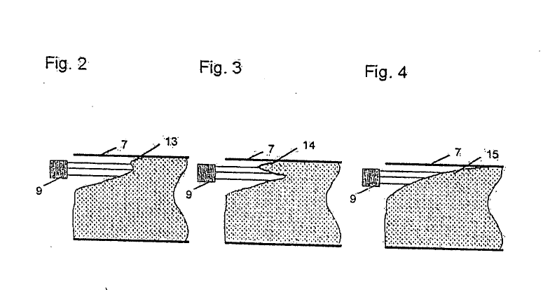

FIG. 2 shows a foaming-up profile with little overlapping 13. Immediately below the upper outer layer 7 the foam flows contrary to the conveying direction 2. FIG. 3 shows a foaming-up profile with strong overlapping 14, wherein the foam below the upper outer layer 7 flows considerably contrary to the conveying direction 2. FIG. 4 shows a foaming profile without overlapping 15, wherein below the upper outer layer 7 no flow of foam occurs contrary to the conveying direction 2.

For the purpose of implementing the closed-loop control, the difference between the actual profile and the set profile is evaluated. This may be undertaken, for example, in such a way that a fitted curve is constructed by means of the actual profile values ascertained metrologically. In this connection, it may be a question of a regression line or of a polynomial—for example, a spline polynomial—or of wavelets.

For the purpose of determining a correcting variable, the differing gradients of the actual profile curves and set profile curves can be drawn upon—that is to say, the difference between the curve gradients is determined. This difference constitutes a measure of the deviation of the actual profile from the set profile.

Alternatively, or in addition, the integrals of the actual profile curves and of the set profile curves may be formed. The difference of the two integrals yields, in turn, a measure of the deviation of the actual profile from the set profile.

Alternatively, or in addition, the points of inflection of the actual curves and set curves may also be used to determine a correcting variable. Typically, in the case of the foaming-up profile with an overlapping curve is obtained having a point of inflection that can be used to determine the correcting variable.

On the basis of the deviation between the actual profile and the set profile, a correcting variable is ascertained for the purpose of readjustment of the foam process. If the actual profile differs from the set profile, the speed of the conveyor belt 1, for instance, can be adapted. Alternatively, or in addition, the quantity of the reactive chemical system applied by the mixing head 3 per unit time, the composition of the reactive chemical system, and/or the process temperatures (for example, the temperatures of the reaction components or of the outer layers) can be adapted.

The closed-loop control of the foam process is effected via the regulator 12. The regulator 12 contains a module for determining the actual profile. The regulator 12 further contains a module for the comparison of the ascertained actual profile with the stored set profile. A measure index is computed which indicates a measure of the deviation of the actual profile from the set profile. This measure index serves for ascertaining a correcting variable for the readjustment of the process.

The plant further has a computer system (not shown) with a module for predicting at least one product property of the sheet of foamed material that is produced, with a table for classifying the predicted quality of the foamed material that is produced, and also with a database. In the database, the quality of the predicted product quality in the longitudinal direction of the foam sheets can be stored—that is to say, for a certain point in the foam sheet being continuously produced the predicted product quality is stored in the database. The computer system receives the actual profile curve by way of input variable. Alternatively, only the measured actual profile values are input. Furthermore, the ascertained measure index, which indicates the measure of the deviation between the actual profile curve and the set profile curve, may also be input into the computer system.

On the basis of these input values, one or more product properties of the foamed material currently being produced is/are predicted. The predicted product properties may be, for example, the compressive strengths or the tensile strengths.

By means of the predicted product properties, a classification of the quality is then undertaken by accessing a table in which permissible tolerance values for the product properties are stored, according to product quality. The predicted product properties and the quality assigned to them for foamed material currently being produced are then saved in the database.

Ordinarily, the foamed material resulting from the continuous foam process is subdivided into sheets with a length of 6 m, for example. The plant has a cutting device (not shown) for this purpose. This cutting device is preferably activated by the computer system. If the computer system predicts a section of the continuously produced foam sheet will have a lesser quality, this section is cut out of the foam sheet as a result of activation of the cutting device. In this manner, it is possible for the waste of the foam process to be reduced.

One embodiment of the prediction module is a neural network. The input variables of the neural network are the actual foaming-up profile, the composition of the reactive chemical system which is applied by the mixing head 3 onto the conveyor belt 1, and also parameters of the plant, such as, for example, pressures and temperatures, and preferably also environmental parameters such as, for example, the atmospheric pressure. From these input variables the neural network predicts one or more product properties. The training data that are required for training the neural network can be obtained by separate series of experiments or by acceptance of data pertaining to a current production run.
List of Reference Symbols
Conveyor belt 1
Conveying direction 2
Mixing head 3
Application plate 4
Expanding foam 5
Lower outer layer 6
Upper outer layer 7
Rollers 8
Measuring device 9
Foaming-up profile 10
Bus system 11
Regulator 12
Foam profile with little overlapping 13
Foam profile with great overlapping 14
Foam profile without overlapping 15

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1 A method for producing sheets of foamed material in a continuous foam process comprising:
a) detecting an actual foaming-up profile for a given foam-forming mixture parallel to the conveying direction of the conveyor belt,
b) determining a correcting variable for the foam process as a function of a deviation of the actual foaming-up profile of the foam-forming mixture from the reference foaming-up profile, and
c) adjusting the foam process by changing the correcting variable to make the actual foaming-up profile of the foam-forming mixture correspond to the reference foaming-up profile.

2. The method of claim 1 in which the foamed material is polyurethane foam.

3. The method of claim 1 in which the continuous foam process is conducted with a twin-belt conveying plant.

4. The method of claim 1 in which the actual foaming-up profile is detected with measurement sensors.

5. The method of claim 1 in which conveying speed is the correcting variable.

6. The method of claim 1 in which quantity of material supplied to the foam process per unit time is the correcting variable.

7. The method of claim 1 in which chemical composition of material supplied to the foam process is the correcting variable.

8. The method of claim 1 in which temperature of material supplied to the foam process is the correcting variable.

9. The method of claim 1 in which temperature of application plate is the correcting variable.

10. The method of claim 1 in which temperature of outer layers supplied to the foam process is the correcting variable.

11. The method of claim 1 in which temperature of molding-chamber press is the correcting variable.

12. The method of claim 1 in which at least one product property of a sheet of foamed material located in a region along the foamed material's conveying direction is predicted as a function of the actual foaming-up profile.

13. The method of claim 12 in which the prediction of the product property is made by means of a regression model.

14. The method of claim 12 in which the prediction of the product property is made by means of a neural network or by means of a hybrid neural network.

15. The method of claim 14 in which the actual foaming-up profile is input to the neural network by way of input parameter.

16. The method of claim 12 in which the product property is used to classify quality of the foamed material.

17. The method of claim 16 in which regions of the foamed material that have a low quality are cut out.

18. A plant for producing foamed material in a continuous foam process comprising:
a) means for detecting actual foaming-up profile of a sheet of foamed material,
b) means for determining a correcting variable for the foam process as a function of a deviation of the actual foaming-up profile from a predetermined reference foaming-up profile.

19. The plant of claim 18 comprising a twin-belt conveying apparatus.

20. The plant of claim 18 in which the means for detecting the actual foaming- up profile comprises at least one laser distance sensor or laser scanner or ultrasonic sensor or CCD camera.

21. The plant of claim 18 in which the means for determining a correcting variable is a device for determining conveying speed of foam-forming mixture.

22. The plant of claim 18 in which the means for determining a correcting variable is a device capable of determining quantity of foam-forming material to be supplied to the foam process per unit time.

23. The plant of claim 18 in which the means for determining a correcting variable is a device capable of determining chemical composition of material to be supplied to the foam process.

24. The plant of claim 18 in which the means for determining a correcting variable is a device capable of determining temperature of material supplied to the foam process.

25. The plant of claim 18 in which the means for determining a correcting variable is a device capable of determining temperature of an application plate.

26. The plant of claim 18 in which the means for determining a correcting variable is a device capable of determining the temperature of outer layers supplied to the foam process.

27. The plant of claim 18 in which the means for determining a correcting variable is a device capable of determining molding-chamber press temperature.

28. The plant of claim 18 further comprising means for predicting at least one product property of foamed material as a function of the actual foaming-up profile, which means is positioned along conveying direction of foam- forming mixture.

29. The plant of claim 28 further comprising means for controlling a cutting device for dividing foamed material into sheets having a predicted product property.
